(19) United States
(12) Patent Application Publication
(10) Pub. No.: US 2019/0345325 A1
(43) Pub. Date: Nov. 14, 2019

(54) RESIN COMPOSITION FOR PRINTED CIRCUIT BOARD AND INTEGRATED CIRCUIT PACKAGE, AND PRODUCT USING THE SAME

(71) Applicant: SAMSUNG ELECTRONICS CO., LTD., Suwon-si (KR)

(72) Inventors: Hyung-Mi JUNG, Suwon-si (KR); Ki-Seok KIM, Suwon-si (KR); Ji-Hye SHIM, Suwon-si (KR); Hwa-Young LEE, Suwon-si (KR)

(73) Assignee: SAMSUNG ELECTRONICS CO., LTD., Suwon-si (KR)

(21) Appl. No.: 16/354,931

(22) Filed: Mar. 15, 2019

(30) Foreign Application Priority Data
May 11, 2018 (KR) 10-2018-0054394
Sep. 12, 2018 (KR) 10-2018-0109017

(51) Int. Cl. C08L 63/04; C08K 5/3492; C08K 5/00; H01B 3/40; C08G 59/02; C08G 59/24

(52) U.S. Cl. CPC C08L 63/04; C08K 5/3492; C08K 5/0066; C08K 5/0025; C08L 2203/206; C08G 59/027; C08G 59/245; C08L 2201/02; H01B 3/40

(57) ABSTRACT

A resin composition for a printed circuit board and an integrated circuit (IC) package, and a product using the same is provided. The resin composition includes an epoxy resin composite comprising an epoxy group, the epoxy resin composite including 5 to 20 parts by weight of a bisphenol A type epoxy resin, 30 to 60 parts by weight of a cresol novolak epoxy resin, 20 to 35 parts by weight of a phosphorus-based flame-retardant epoxy resin, and 5 to 30 parts by weight of a rubber-modified epoxy resin, based on 100 parts by weight of the epoxy resin composite, an aminotriazine-based hardener, a hardening accelerator, a filler, and 0.01 to 5 parts by weight of a surface improving agent based on 100 parts by weight of the epoxy resin composite.

### CROSS-REFERENCE TO RELATED APPLICATION(S)

This application claims the benefit under 35 USC § 119(a) of Korean Patent Application No. 10-2018-0054394 filed on May 11, 2018 and Korean Patent Application No. 10-2018-0109017 filed on Sep. 12, 2018, in the Korean Intellectual Property Office, the entire disclosures of which are incorporated herein by reference for all purposes.

### BACKGROUND

### 1. Field

This application relates to a resin composition for a printed circuit board (PCB) and an integrated circuit (IC) package, and a product using the same.

### 2. Description of Related Art

With the development of electronic devices with higher performance, higher capacity, and slimmer form factors, printed circuit boards of electronic devices are implemented with various advanced functionalities in addition to having a thin form factor.

Recently, microcircuits have been formed after lamination of an insulation film instead of a using the one-step process of laminating a copper foil and a PPG with a typical V-press.

With such a new method, new insulation materials which have excellent adhesion to a plating layer compared to the typical insulation material have to be developed. Particularly, adhesion to a wiring material must be improved in order to secure reliability in harsh environments such as drop reliability. Accordingly, an insulation material that is excellent in peel-strength is needed.

Furthermore, since a build-up material can be used in various ways as a back-side redistribution layer (RDL) and a molding material in PCB-based panel level packaging (PLP), the development of insulation compositions, which can secure the reliability of PCBs and packages, is needed.

### SUMMARY

This Summary is provided to introduce a selection of concepts in a simplified form that are further described below in the Detailed Description. This Summary is not intended to identify key features or essential features of the claimed subject matter, nor is it intended to be used as an aid in determining the scope of the claimed subject matter.

In a general aspect, a resin composition includes an epoxy resin composite including 5 to 20 parts by weight of a bisphenol A type epoxy resin, 30 to 60 parts by weight of a cresol novolak epoxy resin, 20 to 35 parts by weight of a phosphorus-based flame-retardant epoxy resin, and 5 to 30 parts by weight of a rubber-modified epoxy resin, based on 100 parts by weight of the epoxy resin composite, an aminotriazine-based hardener, a hardening accelerator, a filler, and 0.01 to 5 parts by weight of a surface improving agent based on 100 parts by weight of the epoxy resin composite.

The resin composition may be implemented in a printed circuit board (PCB) or an integrated circuit (IC) package.

The epoxy resin composite may include 5 to 15 parts by weight of the bisphenol A type epoxy resin, 50 to 60 parts by weight of the cresol novolak epoxy resin, 25 to 35 parts by weight of the phosphorus-based flame-retardant epoxy resin, and 5 to 20 parts by weight of the rubber-modified epoxy resin, based on 100 parts by weight of the epoxy resin composite.

An average epoxy resin equivalent of the bisphenol A type epoxy resin may be 100 to 700 g/eq.

An average epoxy resin equivalent of the cresol novolak epoxy resin may be 100 to 600 g/eq.

An average epoxy resin equivalent of the phosphorus-based flame-retardant epoxy resin may be 400 to 800 g/eq.

An average epoxy resin equivalent of the rubber-modified epoxy resin may be 100 to 500 g/eq.

The aminotriazine-based hardener may be contained in an amount of 0.2 to 1.5 equivalent ratio based on a mixed equivalent of a sum of epoxy groups of the epoxy resin composite.

The hardening accelerator may be contained in an amount of 0.1 to 1 part by weight based on 100 parts by weight of the epoxy resin composite.

The filler may be contained in an amount of 20 to 50 parts by weight based on 100 parts by weight of the (a) epoxy resin composite.

The filler may be an organic filler.

The resin composition may further include at least one of an antifoaming agent and a viscosity enhancer.

An insulation film may include the resin composition.

The insulation film may be a build-up insulation film having a thickness of 100 μm or less.

The insulation film may be a mold film having a thickness of 100 μm or more.

The insulation film may be applied to at least one of a build-up layer of a printed circuit board, a mold layer of panel level packaging, and a redistribution layer.

A product may include the insulation film.

The product may be at least one of a printed circuit board and an integrated circuit (IC) package.

Other features and aspects will be apparent from the following detailed description, the drawings, and the claims.

### BRIEF DESCRIPTION OF DRAWINGS

FIG. 1 is a schematic view illustrating an example of a package including a resin composition, where an insulation film prepared by using the resin composition according to an embodiment of this disclosure is provided in an “A” portion;

FIG. 2A to FIG. 2D are graphs illustrating examples of tensile strength and elongation of an insulation film based on a content of a rubber-modified epoxy resin in a resin composition;

FIG. 3 is a graph illustrating an example of peel-strength of an insulation film based on a content of a rubber-modified epoxy resin in a resin composition;

FIG. 4 is a graph illustrating an example of water absorption rate and coefficient of thermal expansion (CTE) of an insulation film based on an aminotriazine-based hardener in a resin composition;

FIG. 5 is a graph illustrating an example of the minimum viscosity based on the type and content of a hardening accelerator in a resin composition;

FIG. 6A to FIG. 6E are images illustrating examples of coating results based on a content of a surface improving agent in a resin composition; and

FIG. 7A to FIG. 7C are images illustrating examples of coating results based on a content of a surface improving agent in a resin composition.

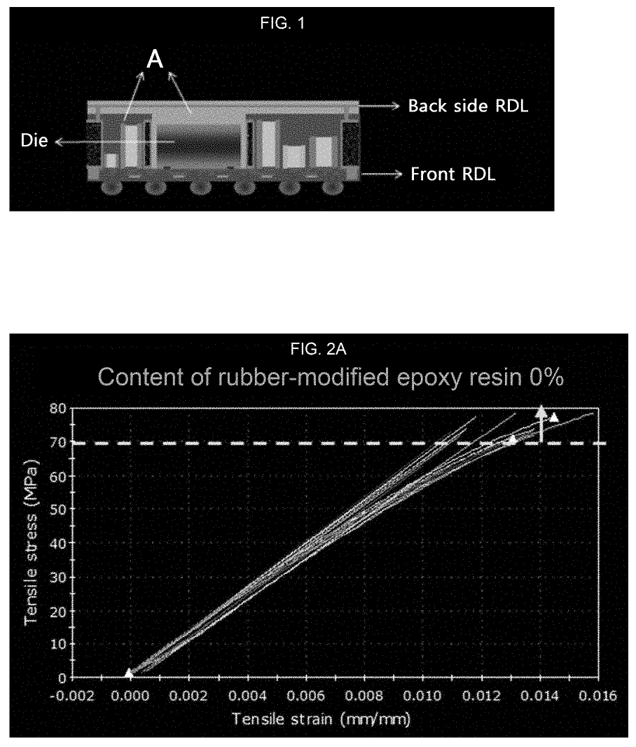

Throughout the drawings and the detailed description, the same reference numerals refer to the same elements. The drawings may not be to scale, and the relative size, proportions, and depiction of elements in the drawings may be exaggerated for clarity, illustration, and convenience.

### DETAILED DESCRIPTION

The following detailed description is provided to assist the reader in gaining a comprehensive understanding of the methods, apparatuses, and/or systems described herein. However, various changes, modifications, and equivalents of the methods, apparatuses, and/or systems described herein will be apparent after an understanding of the disclosure of this application. For example, the sequences of operations described herein are merely examples, and are not limited to those set forth herein, but may be changed as will be apparent after an understanding of the disclosure of this application, with the exception of operations necessarily occurring in a certain order. Also, descriptions of features that are known in the art may be omitted for increased clarity and conciseness.

The features described herein may be embodied in different forms, and are not to be construed as being limited to the examples described herein. Rather, the examples described herein have been provided merely to illustrate some of the many possible ways of implementing the methods, apparatuses, and/or systems described herein that will be apparent after an understanding of the disclosure of this application.

Throughout the specification, when an element, such as a layer, region, or substrate, is described as being “on,” “connected to,” or “coupled to” another element, it may be directly “on,” “connected to,” or “coupled to” the other element, or there may be one or more other elements intervening therebetween. In contrast, when an element is described as being “directly on,” “directly connected to,” or “directly coupled to” another element, there can be no other elements intervening therebetween.

As used herein, the term “and/or” includes any one and any combination of any two or more of the associated listed items.

Although terms such as “first,” “second,” and “third” may be used herein to describe various members, components, regions, layers, or sections, these members, components, regions, layers, or sections are not to be limited by these terms. Rather, these terms are only used to distinguish one member, component, region, layer, or section from another member, component, region, layer, or section. Thus, a first member, component, region, layer, or section referred to in examples described herein may also be referred to as a second member, component, region, layer, or section without departing from the teachings of the examples.

Spatially relative terms such as “above,” “upper,” “below,” and “lower” may be used herein for ease of description to describe one element's relationship to another element as shown in the figures. Such spatially relative terms are intended to encompass different orientations of the device in use or operation in addition to the orientation depicted in the figures. For example, if the device in the figures is turned over, an element described as being “above” or “upper” relative to another element will then be “below” or “lower” relative to the other element. Thus, the term “above” encompasses both the above and below orientations depending on the spatial orientation of the device. The device may also be oriented in other ways (for example, rotated 90 degrees or at other orientations), and the spatially relative terms used herein are to be interpreted accordingly.

The terminology used herein is for describing various examples only, and is not to be used to limit the disclosure. The articles “a,” “an,” and “the” are intended to include the plural forms as well, unless the context clearly indicates otherwise. The terms “comprises,” “includes,” and “has” specify the presence of stated features, numbers, operations, members, elements, and/or combinations thereof, but do not preclude the presence or addition of one or more other features, numbers, operations, members, elements, and/or combinations thereof.

Due to manufacturing techniques and/or tolerances, variations of the shapes shown in the drawings may occur. Thus, the examples described herein are not limited to the specific shapes shown in the drawings, but include changes in shape that occur during manufacturing.

The features of the examples described herein may be combined in various ways as will be apparent after an understanding of the disclosure of this application. Further, although the examples described herein have a variety of configurations, other configurations are possible as will be apparent after an understanding of the disclosure of this application.

A. Resin Composition

A resin composition for a printed circuit board and/or an IC package according to an embodiment of this disclosure includes: (a) an epoxy resin composite including 5 to 20 parts by weight of a bisphenol A type epoxy resin, 30 to 60 parts by weight of a cresol novolak epoxy resin, 20 to 35 parts by weight of a phosphorus-based flame retardant epoxy resin, and 5 to 30 parts by weight of a rubber-modified epoxy resin, based on 100 parts by weight of the epoxy resin composite; (b) an aminotriazine-based hardener; (c) a hardening accelerator; (d) an inorganic filler; and (e) 0.01 to 5 parts by weight of a surface improving agent based on 100 parts by weight of the epoxy resin composite.

(a) Epoxy Resin Composite

Bisphenol a Type Epoxy Resin

An average epoxy resin equivalent of the bisphenol A type epoxy resin may be, but is not limited to, 100 to 700 g/eq. When the average epoxy resin equivalent is less than 100 g/eq, it may be difficult to exhibit desired physical properties. On the other hand, when the average epoxy resin equivalent is more than 700 g/eq, it may be difficult to dissolve in a solvent and a melting point may thus become too high.

The bisphenol A epoxy resin may be contained in an amount of 5 to 20 parts by weight based on 100 parts by weight of the epoxy resin composite. When the content of the bisphenol A type epoxy resin is less than 5 parts by weight, adhesion with a wiring material may be deteriorated. On the other hand, when the content is more than 20 parts by weight, thermal stability and electrical properties may be deteriorated. Although not limited thereto, the bisphenol A epoxy resin may be preferably used in an amount of 5 to 15 parts by weight based on 100 parts by weight of the epoxy resin composite.

Cresol Novolak Epoxy Resin

The epoxy resin composite includes a cresol novolac epoxy resin to provide a cured product having improved thermal stability and high heat resistance. The average epoxy resin equivalent of the cresol novolac epoxy resin in the epoxy resin composite is not limited to, but may be in a range of 100 to 600 g/eq.

The cresol novolak epoxy resin may be contained in an amount of 30 to 60 parts by weight based on 100 parts by weight of the epoxy resin composite. When the content of the cresol novolak epoxy resin is less than 30 parts by weight, it may be difficult to obtain desired physical properties. On the other hand, when the content is more than 60 parts by weight, electrical or mechanical properties may be deteriorated. The content of the cresol novolac epoxy resin may be 30 to 60 parts by weight, 40 to 60 parts by weight, or 50 to 60 parts by weight, and preferably 50 to 60 parts by weight based on 100 parts by weight of the epoxy resin composite.

Phosphorus-Based Flame-Retardant Epoxy Resin

The epoxy resin composite may include a phosphorus-based flame-retardant epoxy resin to provide a cured product having high flame retardancy. The average epoxy resin equivalent of the phosphorus-based flame-retardant epoxy resin in the epoxy resin composite is not limited to, but may be in a range of 400 to 800 g/eq. When the average epoxy resin equivalent is less than 400 g/eq, it may be difficult to obtain desired physical properties. On the other hand, when the average epoxy resin equivalent is more than 800 g/eq, it may be difficult to dissolve in a solvent and a melting point may thus become too high.

The phosphorus-based flame-retardant epoxy resin may be contained in an amount of 20 to 35 parts by weight based on 100 parts by weight of the epoxy resin composite. When the content of the phosphorus-based flame-retardant epoxy resin is less than 20 parts by weight, it may be difficult to provide suitable flame retardancy in an insulation film. On the other hand, when the content is more than 35 parts by weight, mechanical strength may be lowered. Although not limited thereto, the phosphorus-based flame-retardant epoxy resin may be preferably contained in an amount of 20 to 35 parts by weight, and more preferably 25 to 35 parts by weight.

Rubber-Modified Epoxy Resin

The epoxy resin composite may include a rubber-modified epoxy resin. As a content of the rubber-modified epoxy increases, mechanical properties and adhesion after hardening may be affected.

Although not limited thereto, an equivalent epoxy resin equivalent of the rubber-modified epoxy resin may be 100 to 500 g/eq. When the average epoxy resin equivalent is less than 100 g/eq, it may be difficult for the desired physical properties to be exhibited. On the other hand, when the average epoxy resin equivalent is more than 500 g/eq, it may be difficult to dissolve in a solvent and a melting point may thus become too high to control.

The rubber-modified epoxy resin may be contained in an amount of 5 to 30 parts by weight based on 100 parts by weight of the epoxy resin composite. When the content of the rubber-modified epoxy resin is less than 5 parts by weight, it may be difficult to provide mechanical stability of an insulation film and it may not be suitable for forming a circuit board to which an insulation material is applied. As the content of the rubber-modified epoxy resin increases, tensile strength, elongation and adhesion of the film after hardening may be improved. However, when the content is more than 30 parts by weight, adhesion improving effect may not be large. Although not limited thereto, the rubber-modified epoxy resin may be contained in an amount of 5 to 30 parts by weight, 5 to 25 parts by weight, or 5 to 20 parts by weight, and more preferably 5 to 20 parts by weight.

(b) Hardener

The hardener contained in the resin composition of this disclosure may be an aminotriazine-based hardener in order to improve coefficient of thermal expansion (CTE) characteristics and hardening density. In the disclosed examples, a water absorption rate can be controlled while lowering the CTE by using the aminotriazine-based hardener which has many functional groups, compared with use of a typical novolac hardener.

The hardener is not limited thereto, but may be contained in an amount of 0.2 to 1.5 equivalent ratio based on a mixed equivalent of the epoxy group of the epoxy resin composite, preferably 0.2 to 1.0 equivalent, and more preferably 0.2 to 0.8 equivalent. It is possible to optimally select 0.6 equivalents which satisfies the target CTE of 40 ppm/° C. and does not increase a water absorption rate. When the equivalent ratio of the hardener is less than 0.2, flame retardancy of the composition may be deteriorated. On the other hand, when the equivalent ratio is more than 1.5, adhesion to a wiring layer may be deteriorated and storage stability may be thus deteriorated.

(c) Hardening Accelerator

A hardening accelerator contained in the resin composition of the disclosed examples is not limited thereto. The hardening accelerator may be an imidazole-based compound, and examples thereof include 2-ethyl-4methyl imidazole, 1-(2-cyanoethyl)-2-alkyl imidazole, 2-phenyl imidazole and a mixture thereof.

The hardening accelerator is not limited thereto, but may be included in an amount of 0.1 to 1 part by weight based on 100 parts by weight of the epoxy resin composite. Since a cured product may maintain the minimum viscosity of 1,000 Pa·s or less, flowability may be provided, which may further improve processability.

When the content of the hardening accelerator is less than 0.1 parts by weight, a hardening rate may be remarkably lowered. On the other hand, when the content is more than 1 part by weight, hardening may occur rapidly and it may thus be difficult to provide desired physical properties.

(d) Inorganic Filler

An inorganic filler contained in the resin composition of the disclosed examples may be, but is not limited to, at least one of barium titanium oxide, barium strontium titanate, titanium oxide, lead zirconium titanate, lead lanthanum zirconate titanate, lead magnesium niobate-lead titanate, silver, nickel, nickel-coated polymer sphere, gold-coated polymer sphere, tin solder, graphite, tantalum nitride, metal silicon nitride, carbon black, silica, clay, aluminum, and aluminum borate.

The inorganic filler is not limited thereto, but may be included in an amount of 20 to 50 parts by weight based on 100 parts by weight of the epoxy resin composite. When the content of the inorganic filler is less than 20 parts by weight, it may be difficult to provide desired mechanical properties. On the other hand, when the content is more than 50 parts by weight, phase separation may occur. The inorganic filler may be preferably contained in an amount of 30 to 45 parts by weight, although not limited thereto.

Additionally, the inorganic filler may be surface-treated with a silane coupling agent, and it may be preferable to include fillers in different sizes and shapes. Although not limited thereto, as the silane coupling agent, various kinds of amino-based, epoxy-based, acrylic-based, vinyl-based, and the like may be used.

(e) Surface Improving Agent

A surface improving agent contained in the resin composition of this disclosure may be one selected from, but not limited to, an ammonium-based compound, an amine-based compound, an imine-based compound, an amide-based compound and a mixture thereof. The surface improving agent may be included in an amount of 0.01 to 5 parts by weight based on 100 parts by weight of the epoxy resin composite. When the content of the surface improving agent is less than 0.01 parts by weight, dewetting of the surface may occur when the resin composition is coated on a carrier film or a substrate. On the other hand, when the content is more than 5 parts by weight, a dimple may be formed in a coating film, and interfacial delamination may occur during reliability evaluation by a volatile low molecular weight material.

Examples of the surface improving agent include, but are not limited to, polyether modified dimethylpolysiloxane including BYK-345, BYK-348, BYK-346, BYK-UV3510, BYK-BYK-337 or the like. Although not limited thereto, BYK-337 may be used in examples of this disclosure.

In order to facilitate coating and film formation using the resin composition of this disclosure, a different solvent having a different boiling point may be used and the resin composition may include at least one of an antifoaming agent and a viscosity enhancer.

(f) Antifoaming Agent

An antifoaming agent contained in the resin composition of the disclosed examples plays a role of suppressing foaming to improve the water absorption by imparting dispersing effects. When bubbles are generated, the bubbles float on the substrate and cause defective physical properties. By using such a defoaming agent, such defects can be prevented. The antifoaming agent may be, but is not limited to, a silicone type or a non-silicone polymer type.

The antifoaming agent may be included in an amount of 0.01 to 5 parts by weight based on 100 parts by weight of the epoxy resin composite. When the content of the defoaming agent is less than 0.01 parts by weight, adhesion to a wiring material and elongation may be reduced. On the other hand, when the content is more than 5 parts by weight, it may be difficult to provide desired mechanical properties.

(a) Viscosity Enhancer

The resin composition of the disclosed examples may include a viscosity enhancer to form a high viscosity insulation composition. The viscosity enhancer may be selected from inorganic and/or organic viscosity enhancers.

Although not limited thereto, the organic viscosity enhancer may be at least one selected from urea-modified polyamide waxes, thixotropic resins, cellulose ethers, starches, natural hydrocolloids, synthetic biopolymers, polyacrylates, alkali-activated acrylic acid emulsions, and fatty acid alkanamides.

Although not limited thereto, the inorganic viscosity enhancer may be at least one selected from magnesium oxide, magnesium hydroxide, amorphous silica and layered silicate.

Although not limited thereto, the viscosity enhancer may be selected from inorganic viscosity enhancers such as silica. The silica can effectively prevent precipitation without impairing the properties of the resin composition. Although not limited thereto, the viscosity enhancer may be included in an amount of 0.01 to 5 parts by weight based on 100 parts by weight of the epoxy resin composite. When the content of the viscosity enhancer is less than 0.01 parts by weight, adhesion with a wiring material may be deteriorated. On the other hand, when the content is more than 5 parts by weight, it may be difficult to provide desired mechanical properties.

(h) Solvent

In order to facilitate coating and film formation using the resin composition of this disclosure, a different solvent having a different boiling point may be used. The resin composition may be used by dissolving it in a mixed solvent such as 2-methoxyethanol, methylethylketone (MEK), methylenechloride (MC), dimethylformamide (DMF), methylcellosolve (MCS).

B. Insulation Film

By using the resin composition of this disclosure, it is possible to produce an insulation film having improved water absorption, reliability, thermal stability and mechanical properties.

The insulation film may be applied to a buildup layer of a printed circuit board, a mold layer of PLP, and a back-side redistribution layer (RDL).

The insulation film may be a build-up insulation film having a thickness of 100 μm or less. In this case, a film having a thickness of 100 μm or less can be easily produced by using the resin composition containing the surface improving agent.

The insulation film may be a mold film having a thickness of 100 μm or more. In this case, a film having a thickness of 100 μm or more can be easily produced by using the resin composition containing the surface improving agent.

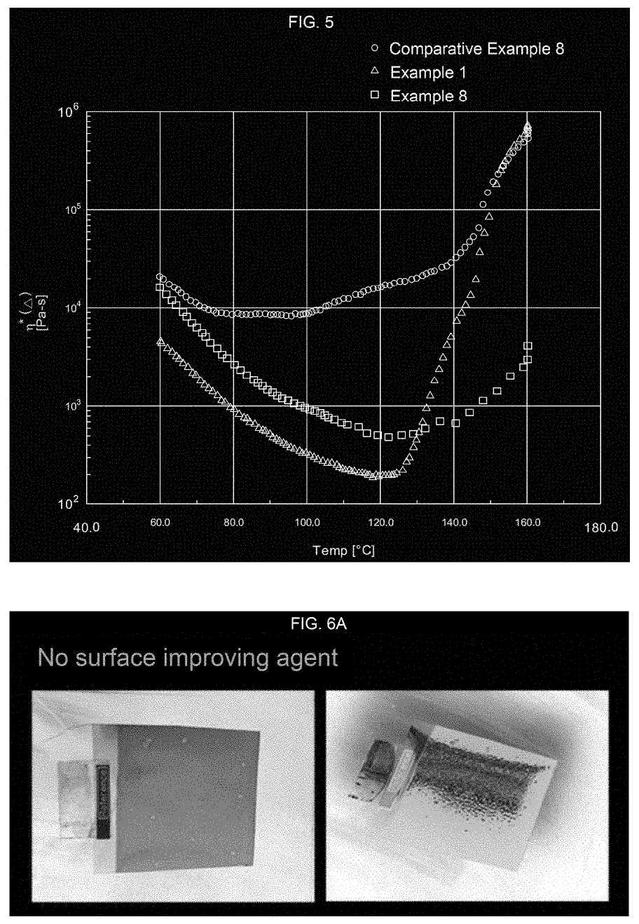

The minimum viscosity of the insulation film may be 1,000 Pa·s or less (FIG. 5). As a result, processing may be facilitated during production of a substrate or the like using the insulation film of the disclosed examples.

C. Package

A printed circuit board and an IC package with improved water absorption, reliability, thermal stability and mechanical properties using the insulation film of the disclosed examples is provided. Particularly, the insulation film of the disclosed examples can be applied to a buildup layer of a printed circuit board, a mold film of PLP, and a back side RDL.

Hereinafter, although more detailed descriptions will be given by examples, those are only for explanation and there is no intention to limit the disclosure. In the following examples, only examples using specific compounds are disclosed. However, it is apparent to those skilled in the art that equivalents of similar compounds can be exhibited even when these equivalents are used.

### Example 1

Preparation of Resin Composition

A resin composition of Example 1 including an epoxy resin composite including a bisphenol A type epoxy resin (KUKDO CHEMICAL Co., LTD., YD011), a novolac epoxy resin (KUKDO CHEMICAL Co., LTD., YDCN), a phosphorus-based epoxy resin (KUKDO CHEMICAL Co., LTD., KDP550), and a rubber-modified epoxy resin(TRUKTOL, Polydis 3616); an aminotriazine-based hardener (GUN EI CHEMICAL INDUSTRY Co., LTD., PS-6313); and a hardening accelerator was prepared.

More particularly, the aminotriazine-based hardener was added in an amount of 0.6 wt % of the epoxy resin composite and spherical silica slurry having a size distribution of 300 nm to 1.2 μm was added and stirred at 300 rpm for 3 hours.

2.5 g of 2-ethyl-4-methyl imidazole as a hardening accelerator and 92.89 g of BYK-337 as an additive were added to the mixture and further mixed at 300 rpm for 1 hour to provide an insulation resin composition. The composition of the resin composition of Example 1 is shown in detail in Table 1.

TABLE 1

| Components | | Weight Ratio |
|---|---|---|
| Epoxy | DGEBA | 10.00% |
| resin | type epoxy | |
| | Naphthalene | 55.00% |
| | type epoxy | |
| | Flame-retardant | 25.00% |
| | epoxy | |
| | Rubber modified | 10.00% |
| | epoxy | |
| Hardener | PS-6313 | 0.6 (Based on |
| | | 100 parts by weight of epoxy |
| | | resin composite) |
| Hardening | 2E4MZ | 0.25 (Based on |
| accelerator | | 100 parts by weight of epoxy |
| | | resin composite) |
| Inorganic | SiO₂ | 33% (Based on |
| filler | | 100 parts by weight of epoxy |
| | | resin composite and hardner) |
| Solvent | MEK | 23.00% |
| | MC | 77.00% |
| Surface | BYK-337 | 1.50 phr |
| improving | | |
| agent | | |
| Additional | MEK | 23% |
| solvent | MC | 77% |

Preparation of Insulation Film and Cured Product

The prepared insulation composition was cast on a polyethylene terephthalate (PET) film to provide a roll-type film product. The prepared product was laminated at a temperature of about 100° C. in a size of 405 mm*510 mm. After laminating, the laminate was cured at about 110° C. for 30 minutes and dismeared to form roughness. Then, a circuit layer having a thickness of about 25 μm was formed through an electroplating process. The circuit layer was cured at 190° C. for 1 hour to provide the final cured product.

### Example 2

The final cured product was provided in the same manner as in Example 1, except that the content of the phosphorus-based flame-retardant epoxy resin in the resin composition was 35 wt %.

### Comparative Example 1

The final cured product was provided in the same manner as in Example 1, except that the phosphorus-base flame-retardant epoxy resin was not added in the resin composition.

### Comparative Example 2

The final cured product was provided in the same manner as in Example 1, except that the content of the phosphorus-based flame-retardant epoxy resin in the resin composition was 15 wt %.

### Example 3

The final cured product was provided in the same manner as in Example 1, except that the content of the rubber-modified epoxy resin in the resin composition was 5 wt %.

### Example 4

The final cured product was provided in the same manner as in Example 1, except that the content of the rubber-modified epoxy resin in the resin composition was 15 wt %.

### Example 5

The final cured product was provided in the same manner as in Example 1, except that the content of the rubber-modified epoxy resin in the resin composition was 30 wt %.

### Comparative Example 3

The final cured product was provided in the same manner as in Example 1, except that the rubber-modified epoxy resin was not added to the resin composition.

### Comparative Example 4

The final cured product was provided in the same manner as in Example 1, except that the content of the rubber-modified epoxy resin in the resin composition was 40 wt %.

### Example 6

The final cured product was provided in the same manner as in Example 1, except that the aminotriazine-based hardener in the resin composition was added in an amount of 0.2 equivalent based on the total amount of the epoxy resin composite.

### Example 7

The final cured product was provided in the same manner as in Example 1, except that the aminotriazine-based hardener in the resin composition was added in an amount of 1.0 equivalent based on the total amount of the epoxy resin composite.

### Comparative Example 5

The final cured product was provided in the same manner as in Example 1, except that a BPA novolac resin hardener (KBN4135) in the resin composition was added in an amount of 0.2 equivalent based on the total amount of the epoxy resin composite.

### Comparative Example 6

The final cured product was provided in the same manner as in Example 1, except that a BPA novolac resin hardener (KBN4135) in the resin composition was added in an amount of 0.6 equivalent based on the total amount of the epoxy resin composite.

### Comparative Example 7

The final cured product was provided in the same manner as in Example 1, except that a BPA novolac resin hardener (KBN4135) in the resin composition was added in an amount of 1.0 equivalent based on the total amount of the epoxy resin composite.

### Example 8

The final cured product was provided in the same manner as in Example 1, except that the content of the hardening accelerator in the resin composition was added at 0.1 wt % based on the total amount of the epoxy resin composite.

### Comparative Example 8

A typical build-up film (ABF Epoxy Film) was used.

### Example 9

The final cured product was provided in the same manner as in Example 1, except that the content of the surface improving agent in the resin composition was 0.1 wt % based on the total amount of the epoxy resin composite.

### Example 10

The final cured product was provided in the same manner as in Example 1, except that the content of the surface improving agent in the resin composition was 0.5 wt % based on the total amount of the epoxy resin composite.

### Example 11

The final cured product was provided in the same manner as in Example 1, except that the content of the surface improving agent in the resin composition was 1.0 wt % based on the total amount of the epoxy resin composite.

### Example 12

The final cured product was provided in the same manner as in Example 1, except that the content of the surface improving agent in the resin composition was 5.0 wt % based on the total amount of the epoxy resin composite.

### Comparative Example 9

The final cured product was provided in the same manner as in Example 1, except that the surface improving agent was not added to the resin composition.

### Comparative Example 10

The final cured product was provided in the same manner as in Example 1, except that the content of the surface improving agent in the resin composition was 0.005 wt % based on the total amount of the epoxy resin composite.

### Comparative Example 11

The final cured product was provided in the same manner as in Example 1, except that the content of the surface improving agent in the resin composition was 6 wt % based on the total amount of the epoxy resin composite.

### Experimental Example 1

Flame retardancy depending on an amount of a phosphorus-based flame-retardant epoxy resin

A flame retardancy test was conducted based on an amount of a phosphorus-based flame-retardant epoxy resin in the resin composition, and the results are shown in Table 2.

As shown in Table 2, it was confirmed that the final products of Example 1 and Example 2, in which the content of the phosphorus-based flame-retardant epoxy resin in the resin composition was 20 wt % or more, were favorable in the flame retardancy test as V-0. On the other hand, the final products of Comparative Example 1 and Comparative Example 2, in which the content of the phosphorus-based flame-retardant epoxy resin in the resin composition was 15% by weight or less, were unfavorable in the flame retardancy test as V-1.

TABLE 2

| | | Content of the | | | | | | | |
|---|---|---|---|---|---|---|---|---|---|
| | | phosphorus-based | | | | | | | |
| Sample | Post-hardening | flame retardant | Test results (After flame time T1, sec.) | | | | | | |
| No. | conditions | epoxy resin (wt %) | 1 | 2 | 3 | 4 | 5 | 6 | Result |
| Comparative | 190° C. 2 hr | 0 | 18 | 20 | 14 | 15 | 22 | 87 | V-1 |
| Example 1 | | | | | | | | | |
| Comparative | 190° C. 2 hr | 15 | 13 | 7.5 | 11 | 10 | 3.5 | 45 | V-1 |
| Example 2 | | | | | | | | | |
| Example 1 | 190° C. 2 hr | 25 | 2.5 | 4 | 3.5 | 3 | 3.5 | 18 | V-0 |
| Example 2 | 190° C. 2 hr | 35 | 3 | 2 | 3 | 2 | 3 | 11 | V-0 |

### Experimental Example 2

Tensile Strength, Elongation and Peel-Strength Based on an Amount of a Rubber-Modified Epoxy Resin

Tensile strength, elongation and peel-strength of the film prepared by varying a content of a rubber-modified epoxy resin in the resin composition were determined, and the results are shown in Table 3.

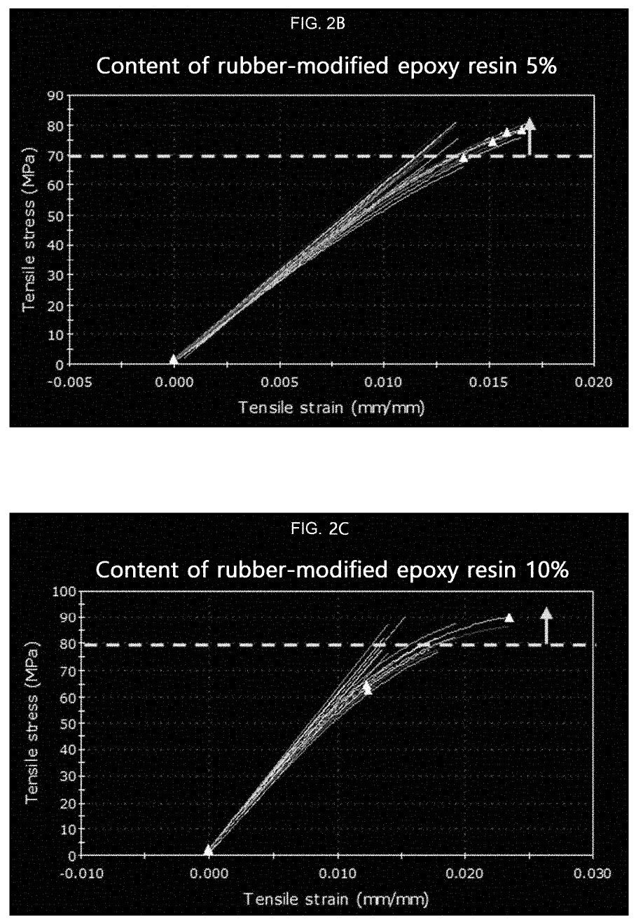

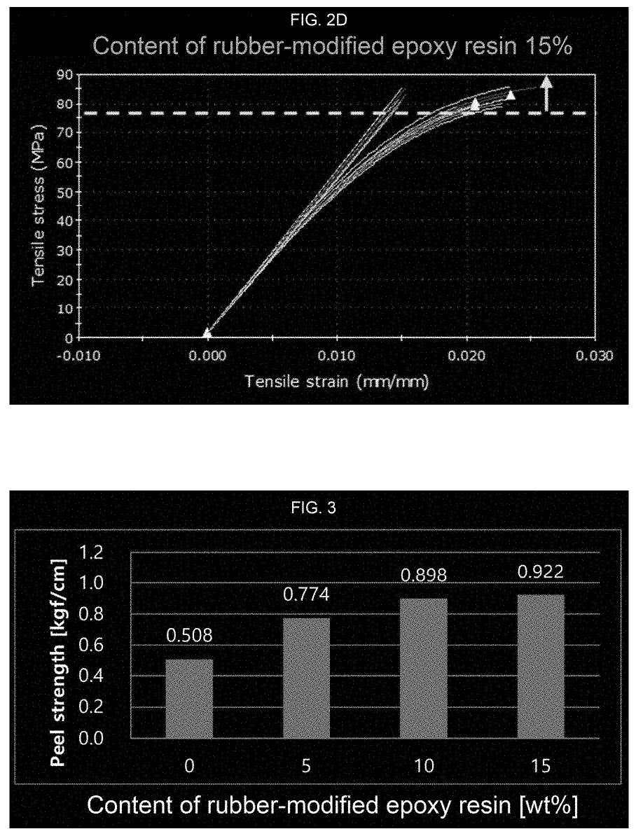

As shown in Table 3, FIGS. 2A to 2D, and FIG. 3, tensile strength, elongation, and peel-strength were excellent when the content of the rubber-modified epoxy resin was in a range of 5 to 30 wt %.

TABLE 3

| | Content of the | Tensile | | |
|---|---|---|---|---|
| Sample | rubber-modified | Strength | Elongation | Adhesion |
| No. | epoxy resin (wt %) | [Mpa] | [%] | [Kgf/cm] |
| Comparative | 0 | 70 | 0.14 | 0.508 |
| Example 3 | | | | |
| Example 3 | 5 | 72 | 0.17 | 0.774 |
| Example 1 | 10 | 80 | 0.25 | 0.898 |
| Example 4 | 15 | 80 | 0.22 | 0.922 |
| Example 5 | 30 | 80 | 1.38 | 0.8 |
| Comparative | 40 | 78 | 0.86 | 0.7 |
| Example 4 | | | | |

### Experimental Example 3

Water Absorption Rate and Coefficient of Thermal Expansion (CTE) Based on the Type and Content of Hardener

As described below, water absorption rate and coefficient of thermal expansion were measured in comparison with an aminotriazine-based hardener of the disclosed examples and a typical novolac hardener, and conditions under which the water absorption rate was controlled while the coefficient of thermal expansion was low were set.

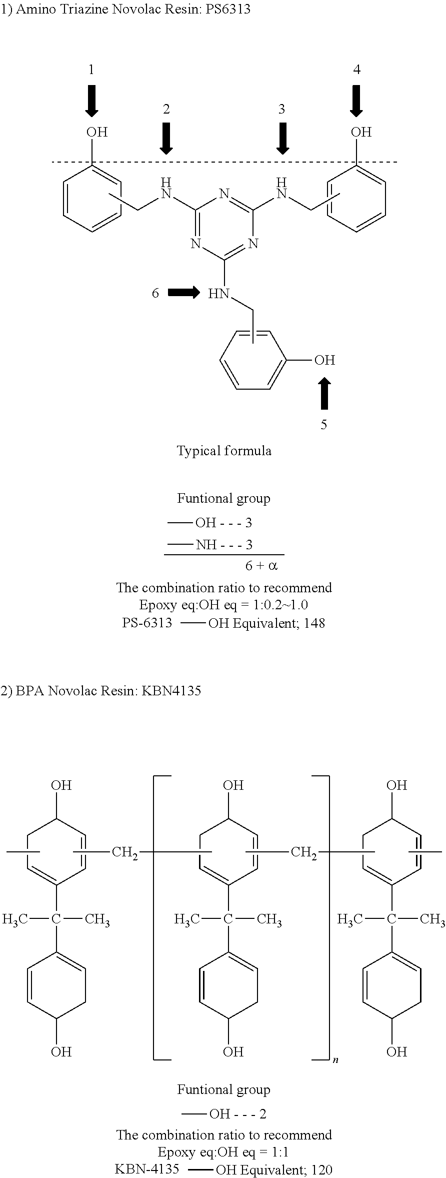

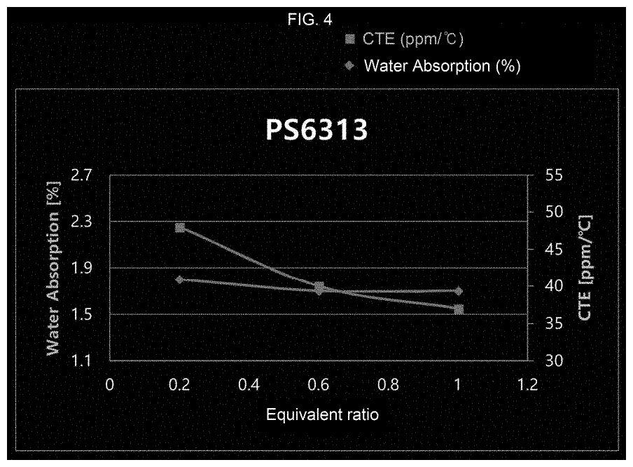

The results are shown in FIG. 4. As shown in FIG. 4, the CTE was low and the water absorption rate was controlled when the aminotriazine-based hardener had —OH equivalent ratio of 0.2 to 1 (Example 1, Example 6, and Example 7).

### Experimental Example 4

Reliability and Viscosity Test

Peel-strength with a Cu pattern was measured after desmearing. The peel-strength with the Cu pattern of the cured product of Example 1 was found to be 0.898 kgf/cm. It was confirmed that the reliability satisfied both Highly Accelerated Stress Test (HAST) and Thermal Cycle (TC) reliability criteria. Table 4 below shows the results of the reliability evaluation of the product prepared in Example 1.

TABLE 4

| Product | | Conditions | Specification | Result |
|---|---|---|---|---|
| Via | QVP | via size | no failure | pass |
| reliability | | 70 μm | mode | |
| | TC/C | −65~150° C. | R-shift <6% | pass |
| | | 1000cycle | | |
| Adhesion | Cu P/S | initial | Min 0.5 | 0.78 |
| | (kdf/cm) | | | |
| | MRT | Max 275° C. | No | pass |
| | | 15X | delamination | |
| Insulation | wiL HAST | 130° C. 85% | >10⁶Ω | pass |
| | L/S = 12/12 μm | 3.5 V 96 hr | | |
| | LtL HAST | 130° C. 85% | >10⁶Ω | pass |
| | DE = 30 μm | 3.5 V 96 hr | | |

Viscosities of the insulation films of Example 1 and Example 8 were determined using a viscometer (ARES, TA Instrument) to evaluate processability thereof. The minimum viscosities were 1,000 Pa·s or less (See FIG. 5) that was a very low value. This difference was 10 times or more as compared with the minimum viscosity of a typical buildup film of Comparative Example 8.

### Experimental Example 5

Surface Coating Depending on an Amount of a Surface Improving Agent

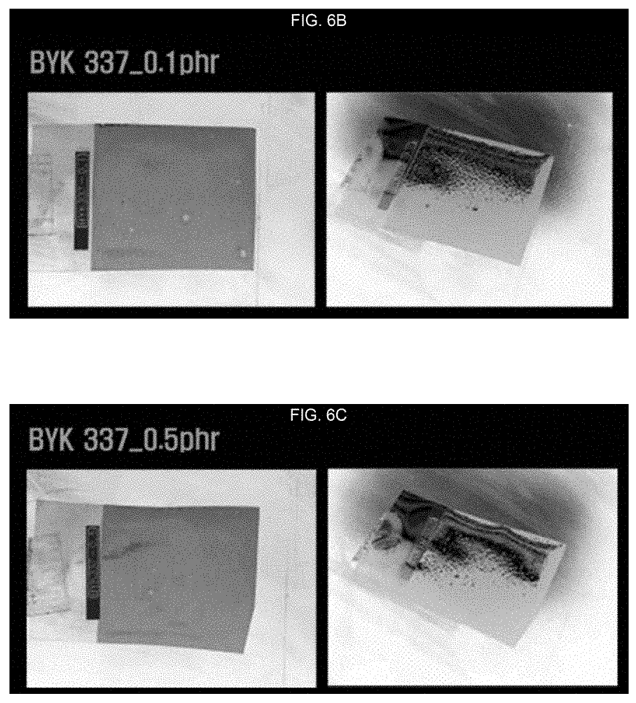

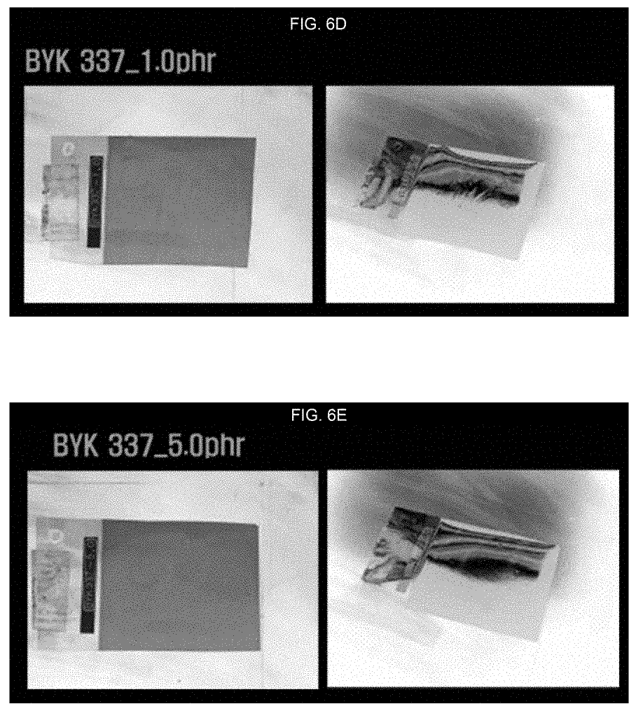

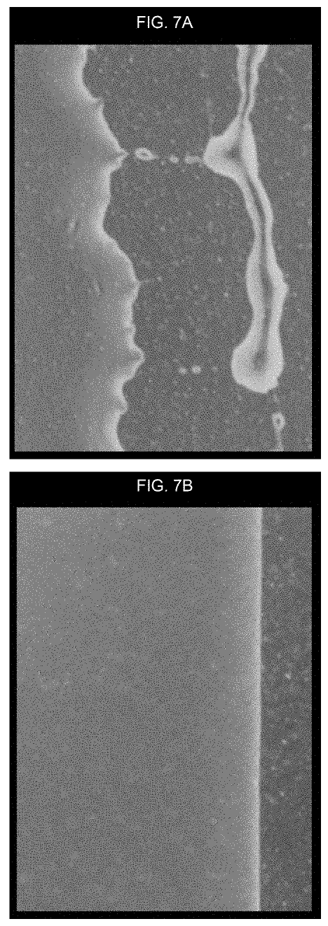

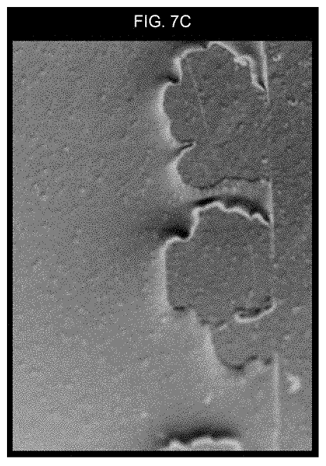

A surface coating test was conducted by varying a content of a surface improving agent in the resin composition. The results are shown in FIG. 6A to FIG. 7C.

As shown in FIG. 6A to FIG. 6E, surface coatings were excellent when the content of the surface improving agent in the resin composition was 0.1 to 5 wt % (Example 9 to Example 12), unlike the case of Comparative Example 9 in which the surface improving agent was not included.

As shown in FIG. 7A, when the content of the surface improving agent is less than 0.01% by weight, the wettability was poor and dewetting was caused when the composition was coated on a carrier film or a substrate.

As shown in FIG. 7B, surface coating was excellent when the content of the surface improving agent in the resin composition was 1.5% by weight as in Example 1.

As shown in FIG. 7C, if the content of the surface improving agent was more than 5% by weight, a dimple was formed in the coating film, it was difficult to control wettability, and interfacial delamination was caused during reliability evaluation due to the volatile low molecular weight material.

On the other hand, it was confirmed that the prepared molding material had low water absorption rate and excellent reliability in a static humidity system (two reflow cycles after 48 hours under condition of 85° C./85% RH).

The dissipation factor (Df) was found to be less than 0.003 tangent (δ).

As described above, the resin composition of the disclosed examples is suitable for package molding, has low moisture content after hardening, and is excellent in adhesion to Cu, and thus has excellent reliability when used as a package molding material. Additionally, a resin composition which is excellent in thermal/mechanical strength such as dissipation factor, TC, drop reliability and the like, may be provided.

Additionally, a film-type molding material may be produced by using the composition of the disclosed examples, and a film with a very high thickness (>200 μm) may be formed, compared with typical insulating materials.

The resin composition of the disclosed examples may also be used as a molding material for packaging to protect circuit boards and chips in which a build-up insulation material is applied in an outer layer, or as a back-side coating layer to protect an outermost layer of a package by utilizing an existing substrate manufacturing method. A substrate and a package having excellent reliability may also be produced when the composition of the disclosed examples is applied.

Additionally, when a typical molding material in a granular or liquid type is used, an expensive compression molding equipment may be needed, and since the molding and hardening are carried out with one equipment, the processing time is also increased. On the other hand, by using the film-type molding material prepared by the resin composition of the disclosed examples, relatively inexpensive lamination equipment can be used and the hardening can be separately performed in a typical oven after molding, which may shorten the processing time and improve the productivity of the final product.

Use of a resin composition as described in this application provides for a printed circuit board and/or an IC package having improved reliability, thermal stability, mechanical strength, and adhesion to a wiring layer.

A build-up insulation film or a mold insulation film including the composition described above is provided, which has improved reliability, thermal stability, mechanical strength, and adhesion to a wiring layer.

A printed circuit board and/or an IC package including the composition described above is provided, which has improved reliability, thermal stability and mechanical strength.

A resin composition for a printed circuit board and/or an IC package is provided, which has low water absorption rate and is thus excellent in reliability and has improved thermal stability, mechanical strength, and adhesion to a wiring layer.

A build-up insulation film or a mold insulation film having improved reliability, thermal stability, mechanical strength, and adhesion to a wiring layer is provided by using the resin composition.

A printed circuit board or an IC package with improved reliability, thermal stability and mechanical strength is provided by using the resin composition.

Relatively inexpensive equipment may be utilized with the insulation film, processing time may be shortened, and the productivity of the substrate and the package may be effectively increased.

The insulation film can be used for large area packaging.

While this disclosure includes specific examples, it will be apparent after an understanding of the disclosure of this application that various changes in form and details may be made in these examples without departing from the spirit and scope of the claims and their equivalents. The examples described herein are to be considered in a descriptive sense only, and not for purposes of limitation. Descriptions of features or aspects in each example are to be considered as being applicable to similar features or aspects in other examples. Suitable results may be achieved if the described techniques are performed in a different order, and/or if components in a described system, architecture, device, or circuit are combined in a different manner, and/or replaced or supplemented by other components or their equivalents. Therefore, the scope of the disclosure is defined not by the detailed description, but by the claims and their equivalents, and all variations within the scope of the claims and their equivalents are to be construed as being included in the disclosure.

What is claimed is:

1. A resin composition comprising:
an epoxy resin composite comprising 5 to 20 parts by weight of a bisphenol A type epoxy resin, 30 to 60 parts by weight of a cresol novolak epoxy resin, 20 to 35 parts by weight of a phosphorus-based flame-retardant epoxy resin, and 5 to 30 parts by weight of a rubber-modified epoxy resin, based on 100 parts by weight of the epoxy resin composite;
an aminotriazine-based hardener;
a hardening accelerator;
a filler; and
0.01 to 5 parts by weight of a surface improving agent based on 100 parts by weight of the epoxy resin composite.

2. The resin composition of claim 1, wherein the resin composition is implemented in at least one of a printed circuit board (PCB) and an integrated circuit (IC) package.

3. The resin composition of claim 1, wherein the epoxy resin composite comprises 5 to 15 parts by weight of the bisphenol A type epoxy resin, 50 to 60 parts by weight of the cresol novolak epoxy resin, 25 to 35 parts by weight of the phosphorus-based flame-retardant epoxy resin, and 5 to 20 parts by weight of the rubber-modified epoxy resin, based on 100 parts by weight of the epoxy resin composite.

4. The resin composition of claim 1, wherein an average epoxy resin equivalent of the bisphenol A type epoxy resin is 100 to 700 g/eq.

5. The resin composition of claim 1, wherein an average epoxy resin equivalent of the cresol novolak epoxy resin is 100 to 600 g/eq.

6. The resin composition of claim 1, wherein an average epoxy resin equivalent of the phosphorus-based flame-retardant epoxy resin is 400 to 800 g/eq.

7. The resin composition of claim 1, wherein an average epoxy resin equivalent of the rubber-modified epoxy resin is 100 to 500 g/eq.

8. The resin composition of claim 1, wherein the aminotriazine-based hardener is contained in an amount of 0.2 to 1.5 equivalent ratio based on a mixed equivalent of a sum of epoxy groups of the epoxy resin composite.

9. The resin composition of claim 1, wherein the hardening accelerator is contained in an amount of 0.1 to 1 part by weight based on 100 parts by weight of the epoxy resin composite.

10. The resin composition of claim 1, wherein the filler is contained in an amount of 20 to 50 parts by weight based on 100 parts by weight of the epoxy resin composite.

11. The resin composition of claim 1, wherein the filler is an organic filler.

12. The resin composition of claim 1, further comprising at least one of an antifoaming agent and a viscosity enhancer.

13. An insulation film comprising the resin composition of claim 1.

14. The insulation film of claim 13, wherein the insulation film is a build-up insulation film having a thickness of 100 μm or less.

15. The insulation film of claim 13, wherein the insulation film is a mold film having a thickness of 100 μm or more.

16. The insulation film of claim 13, wherein the insulation film is applied to at least one of a build-up layer of a printed circuit board, a mold layer of panel level packaging, and a redistribution layer.

17. A product comprising the insulation film of claim 13.

18. The product of claim 17, wherein the product is at least one of a printed circuit board and an integrated circuit (IC) package.
